(19) United States
(12) Patent Application Publication
(10) Pub. No.: US 2007/0081433 A1
(43) Pub. Date: Apr. 12, 2007

(54) TILT ADJUSTMENT SYSTEM AND METHOD OF OPTICAL DISK DEVICE

(75) Inventors: Chih-chung Wu, Pingtung City (TW); Chi-pei Huang, Miaoli City (TW); Chun-ying Chiang, Chiayi City (TW); Kuo-ting Hsin, Chu-tung Town (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Media Tek Inc., Hsin-chu City (TW)

(21) Appl. No.: 11/536,043

(22) Filed: Sep. 28, 2006

Related U.S. Application Data
(60) Provisional application No. 60/725,088, filed on Oct. 7, 2005.

(51) Int. Cl. G11B 7/00

(52) U.S. Cl. 369/44.32

(57) ABSTRACT

The present invention discloses a tilt adjustment system and method of an optical disk device with a pickup head, which includes a decoder for decoding the encoded information from an optical disk and checking whether error occurs during decoding. A decoding error calculator calculates a statistics corresponding to the decoding errors under the different tilts of the pickup head. A tilt control unit utilizes a specific algorithm to determine a decoding error rate, which is minimal than the other error rates within the statistics. Thus, an optimal tilt value can be decided upon the minimal error rate to adjust the tilt of the pickup head.

### CROSS-REFERENCE TO RELATED APPLICATION

The present application claims the benefit of the filing date under 35 U.S.C. § 119(e) of a Provisional U.S. Patent Application No. 60/725,088, filed Oct. 7, 2005, which is incorporated by reference herein.

The present invention relates to a tilt adjustment system and method of an optical disk drive, and especially in a tilt adjustment system and method which controls a tilt between laser beam axis from the pickup head and an optical disk thereby achieving a best recording/reading quality.

Recently, fabrication quality of optical disks or optical disk devices from various fabricators is uneven, especially in assembly of the pickup head. This often causes a tilt angle occurring between a laser beam axis and layer of optical disk. The tilt is greatly involved in reading and writing qualities of optical disk devices, especially in a latest development of the optical disk system on a tendency that the optical disk has a greater capacity or light spot is contiguously microminiaturized for precisely reading/writing operation on the optical disk. For example, a red-ray laser DVD, a blue-ray laser DVD, or a high-density DVD. Thus, it is a significant topic to develop an optical disk device, which is cable to actively adjust tilt on demand thereby achieving better reading and writing qualities.

To address the foregoing drawbacks, a related tilt controlling technology announced usage of a tilt sensor for compensating tilt. Nevertheless, if the tilt sensor had varied characteristics of solid state or an assembly error has existed in the pickup head, an orthogonal relationship between a laser beam axis from the pickup head and an operating layer of optical disk has been broken even during a normal measurement. Furthermore, a pickup head disposed with such a tilt sensor is cost higher. More than that, when the system adjusting tilt by a measured optical signal such as tracking error signal is also possible to achieve poor writing/reading qualities. That's because the tracking error signal for adjusting tilt is always restricted by precision of a servo signal and thus easily results in an inexact tilt.

### SUMMARY OF THE INVENTION

To resolve the aforementioned problems, it is therefore a primary objective of the present invention to provide a tilt adjustment system and method for a pickup head operating on an optical disk. The tilt adjustment system and method use a decoding error read from the optical disk to obtain an optimal tilt value between a laser beam axis from the pickup head and the optical disk.

For a recordable type of optical disk, the tilt adjustment system and method determine number of certain decoded physical address information errors read under the different tilt values until a minimum physical address information error rate is generated corresponding to an optimal tilt value. The minimum physical address information error leads to better reading and writing qualities based on the optimal tilt value.

For read-only type of optical disks or a recordable type of optical disks with data recording, the tilt adjustment system and method determine number of decoded certain data errors read under the different tilt values until a minimum data error rate is generated corresponding to an optimal tilt value. The minimum data error rate leads to better reading and writing qualities based on the optimal tilt value.

To achieve the aforementioned objectives, the present invention provides a tilt adjustment system and method applied for a pickup head operating on an optical disk. The optical disk stores some encoded information having capabilities of error detection and correction. The tilt adjustment system includes a tilt actuator, a decoder, a decoding error calculator and a tilt control unit. The decoder is used to decode the encoded information, which is read from the optical disk by the pickup head, and check whether any one decoding error (i.e. a physical address information error or a data error) occurs during decoding the encoded information.

In a case, the decoding error calculator calculates a statistics containing each decoding error rate, with usage of number of the decoding errors or averaged decoding errors within a specific reading length over the optical disk, or number of decoding errors or averaged decoding errors within a specific reading period for the optical disk. The tilt control unit utilizes a specific algorithm for approaching a minimum decoding error rate, which comprises the steps of modifying tilt value, and then determining whether a decoding error rate generated under the modified tilt value is minimal than the other decoding error rates generated under the other different tilt values or not. Otherwise, the tilt value is successively adjusted until a minimum decoding error rate is determined and an optimal tilt value is decided as a selected tilt value, relative to the minimum decoding error rate.

In the other case, the decoding error calculator further calculates a statistics containing each decoding error rate, with usage of number of the decoding errors or averaged decoding errors within a specific reading length over the optical disk, or number of decoding errors or averaged decoding errors within a specific reading period for the optical disk, and containing the other error rates which are respectively achieved according to the decoding error rates. The tilt control unit utilizes another specific algorithm, which comprises the steps of determining a minimum error rate is minimal than the other errors within the statistics; and then deciding an optimal tilt value as a selected tile value, relative to the minimum error rate. Based on the selected tilt value, the tilt of the pickup head is adjusted.

These and other objectives of the present invention will no doubt become obvious to those of ordinary skill in the art after reading the following detailed description of the preferred embodiment that is illustrated in the various FIGS. and drawings.

### BRIEF DESCRIPTION OF DRAWINGS

FIG. 1A illustrates a schematic architecture diagram of a tilt adjustment system according to the present invention and components;

FIG. 2 illustrates a flow chart indicating a tilt adjustment method showing a series of algorithmic blocks for approaching a minimum decoding error rate; and

FIGS. 3(a), 3(b) and 3(c) illustrate three schematic coordinate diagrams showing a relationship between decoding error rates and tilt values and a process of approaching a minimum decoding error rate depending on the algorithm shown in FIG. 2.

### DETAILED DESCRIPTION

A tilt adjustment method of a pickup head of an optical disk device according to the present invention is disclosed. In a first embodiment of the present invention, a recordable type of optical disk is applied. The recordable type of optical disk such as an empty disk has to be pre-addressed to let the pickup head know where is a rewritable area by way of pre-storing some encoded physical address information on the optical disk. For example, an address in pre-groove (ADIP) for DVD+R or DVD+RW, a land pre-pit (LPP) for DVD-R or DVD-RW, physical identification data (PID) for DVD-RAM, an address in pre-groove (ADIP) for Blue-Ray Disc, and a wobble address in periodic position (WAP) for HD-DVD. These encoded physical address information allocated on the above-mentioned optical disk can direct a tilt adjustment of the pickup head with regard to the optical disk because a tilt variance is greatly involved in a reading quality of the pickup head for those physical address information hidden in wobbles or physical ID embossed on the optical disk. These encoded physical address information have error detection and correction capability, which informs the optical disk device of whether any one decoding error occurs during reading and decoding the encoded physical address information under the tilt of the pickup head with referrer to the optical disk. At each time when the tilt of the pickup head is modified or specified, there might be number of decoded physical address information errors occurring under the modified tilt. A decoded physical address information error rate can be calculated on the basis of the number of decoded physical address information errors. Contiguously, each different tilt value will generate its decoded physical address information errors and each decoded physical address information error rate. Thus, the decoded physical address information error rates achieved by reading the physical address information over the rewriteable type of the optical disk can be considered as a reading/writing quality, which can be referable to adjust a tilt between a laser beam axis from the pickup head and the recordable type of optical disk. Thereafter a decoded physical address information error rate of each modified tilt is compared with the other adjacent error rates generated under the other different tilt values until a minimum physical address information error rate minimal than the other adjacent error rates is eventually approached (detailed later). Furthermore, an optimal tilt value relative to the minimum physical address information error rate is therefore determined as a selected tilt value. Based on the selected tilt value, the tilt of the pickup head is adjusted to ensure better writing/reading qualities.

Alternatively in a second embodiment of the present invention, a read-only type of optical disk or a recordable type of optical disk with data recording is applied. The read-only type of optical disk has not physical address information to use but has some encoded data that are pre-embossed thereon, and also the recordable type of optical disk with data recording has encoded data thereon. Those pre-embossed or encoded data have the same capabilities of error detection and correction as said physical address information. Therefore, the second embodiment of the present invention utilizes an decoded data error read from the read-only type of optical disk by the pickup head to adjust a tilt formed between the laser beam axis from the pickup head and the read-only type of optical disk. Initially, a tilt modification is performed and then a corresponding data error rate is generated by calculating number of data errors that occur during the data decoding under the modified tilt. Thereafter said data error rate is referable to readjust the tilt. Contiguously, some encoded data are decoded from the optical disk to achieve a decoded data error rate under the adjusted tilt. Furthermore, a decoded data error rate of each modified tilt will be compared with the other adjacent error rates generated under the other different tilt values until a minimum data error rate minimal than the other adjacent error rates is eventually approached (detailed later). Furthermore, an optimal tilt relative to the minimum data error rate is therefore determined as a selected tilt value. Based on the selected tilt value, the tilt of the pickup head is adjusted to ensure better writing/reading qualities.

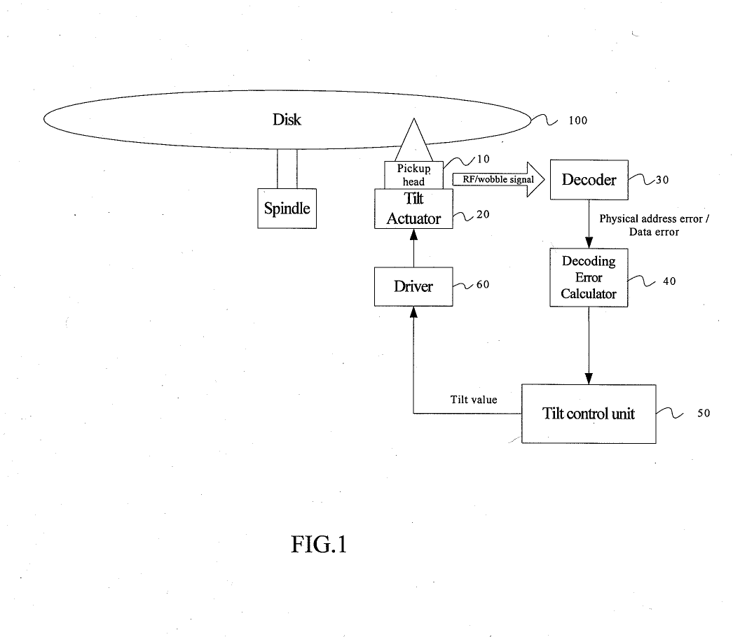

Referring to FIG. 1, a tilt adjustment system according to the present invention is applied for a pickup head that operates on an optical disk 100 having error detection and correction capabilities, for example, a read-only type of optical disk or a recordable type of optical disk. The system primarily includes a pickup head 10, a tilt actuator 20, a decoder 30, a decoding error calculator 40 and a tilt control unit 50. Meanwhile, the pickup head 10 is used to emit a laser beam focusing on a light spot over the optical disk 100 thereby reading/writing data along the tracks of the optical disk 100. The tilt actuator 20 receives an instruction from a driver 60 with reference to each tilt value output from the tilt control unit 50 to adjust the tilt of the pickup head 10 with regard to the optical disk 100. The decoder 30 is used to decode lots of encoded information formed in RF/Wobble signals read by the pickup head 10 from the optical disk 100 and checks whether any one decoding error (i.e. a decoded physical address information error or a data error) occurs during the reading operation.

In a case, the decoding error calculator 40 calculates a statistics such as a decoding error rate (e.g. a decoded physical address error rate or a data error rate) under each specific tilt value, based on the decoding errors transmitted from the decoder 30, for examples, number of decoding errors or averaged number of decoding errors within a specific reading length on the optical disk 100, or number of decoding errors or averaged decoding errors within a specific reading period for the optical disk 100.

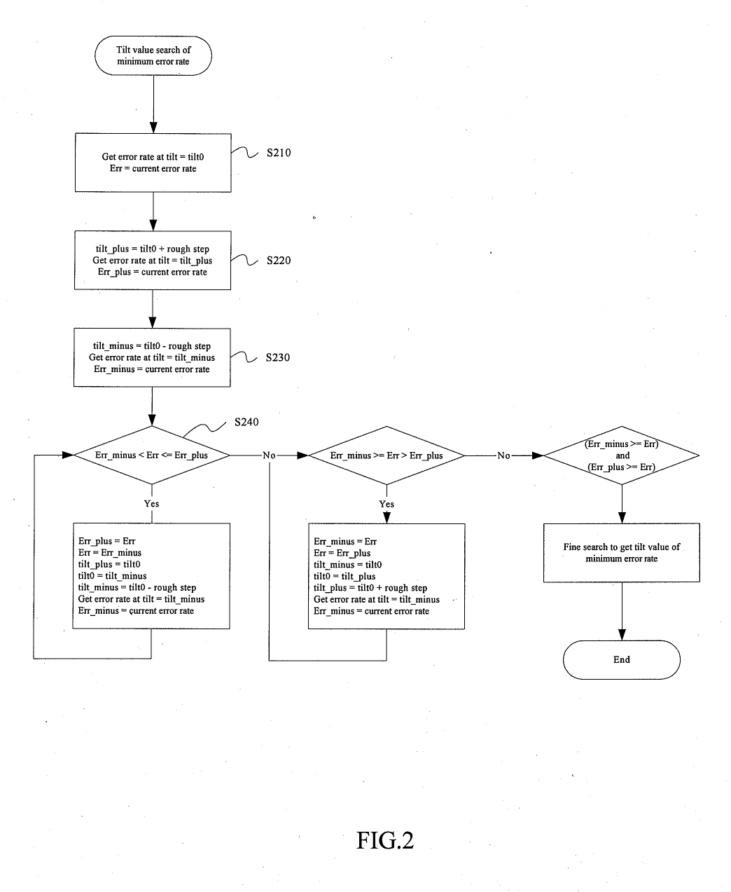

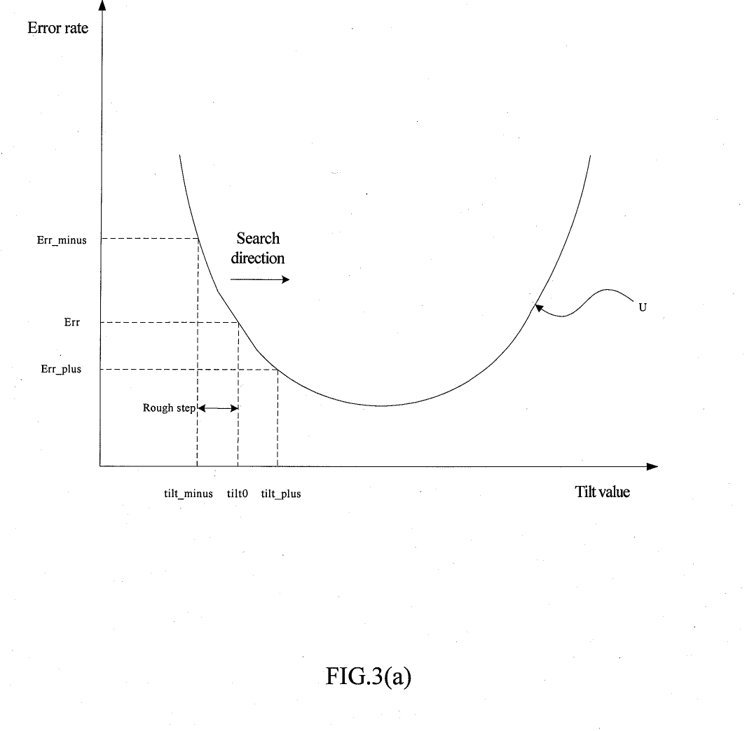

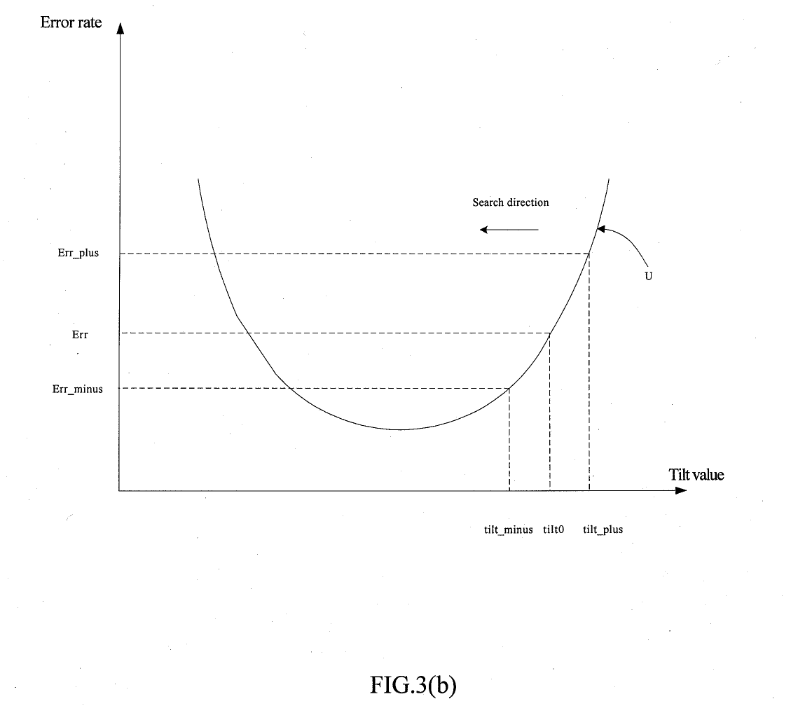

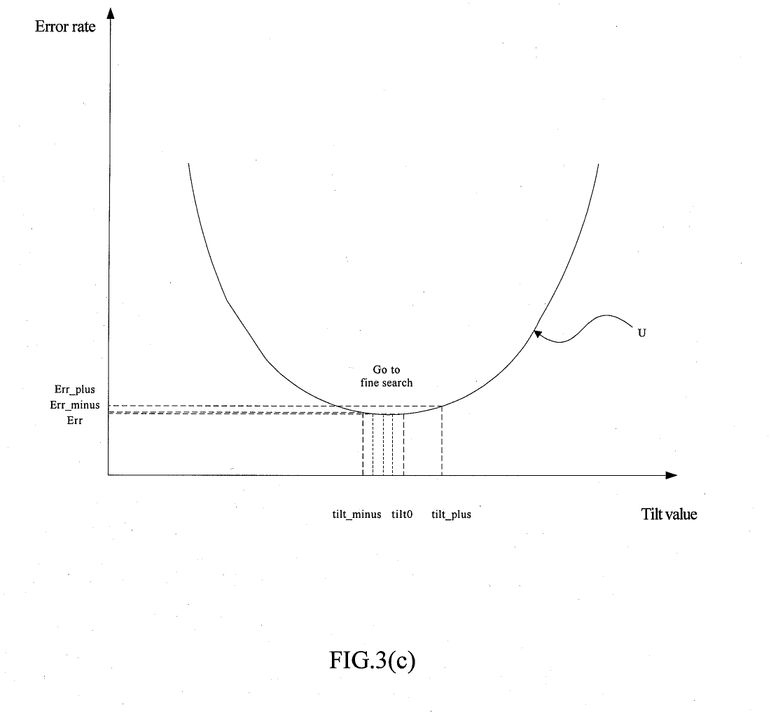

The tilt control unit 50 receives the statistics from the decoding error calculator 40. Then, for the statistics, the tilt control unit 50 initially modifies a tilt value and simultaneously determines whether a decoding error rate calculated by the decoding error calculator 40 under the modified tilt value is minimal than the other adjacent decoding error rates calculated under the other different tilt values or not, or contiguously compares the respective statistic with the other statistics to determine a minimum statistic (as a minimum decoding error rate). Otherwise, the tilt will be contiguously adjusted until a minimum decoding error rate minimal than the other decoding error rates is eventually approached. According to the embodiment of the present invention, the tilt control unit 50 utilizes a specific algorithm, which can approach the minimum decoding error rate. For instance, an algorithmic block diagram as shown in FIG. 2 and three coordinate diagrams shown in FIGS. 3(a), 3(b) and 3(c), which present a relationship between each tilt value and decoding error rate, and a process of approaching a minimum decoding error rate depending on the specific algorithm shown in FIG. 2.

Briefly introduced, in a coordinate of the tilt values and decoding error rates shown in FIG. 3(a), if a “tilt0” is set to be an initial tilt (or a specific tilt) to operate and an error rate “Err” is correspondingly achieved from the decoding error calculator 40 based on the “tilt0” value (as step S210 in FIG. 2). A smaller tilt value as called “tilt_minus” is sought by decreasing the “tilt0” value in a rough step toward the left along a horizontal axis of the coordinate (as step S230 in FIG. 2). A larger error rate “Err_minus” is also calculated from the decoding error calculator 40 based on the smaller tilt “tilt_minus”. A larger tilt “tilt_plus” is sought by increasing the “tilt0” value in another rough step toward the right along the horizontal axis of the coordinate (as step S220 in FIG. 2). A smaller error rate “Err_plus” is also calculated from the decoding error calculator 40 based on the larger tilt “tilt_plus”. Thereafter the various error rates “Err”, “Err_minus” and “Err_plus” can be distinguished (as step S240 in FIG. 2) from each other in a value difference. The three error rates “Err”, “Err_minius” and “Err_plus” are distributed along a negative-sloped side of a curve “U” depicted in the coordinate of FIG. 3(a). This leads the tilt to be adjusted toward the right side of the curve “U” along the horizontal axis of the coordinate.

As shown in FIG. 3(b), after adjusted continuously, the “tilt0” is reset and a new error rate “Err” is correspondingly calculated by the decoding error calculator 40 based on the reset “tilt0”. A smaller tilt “tilt_minus” is sought by decreasing the “tilt0” value in a rough step toward the left along the horizontal axis of the coordinate (as step S230 in FIG. 2). A smaller error rate “Err_minus” is calculated from the decoding error calculator 40 based on the smaller tilt “tilt_minus”. A larger tilt “tilt_plus” is sought by increasing the “tilt0” value in a rough step toward the right along the horizontal axis of the coordinate (as step S220 in FIG. 2). A larger error rate “Err_plus” is also calculated by the decoding error calculator 40 based on the larger tilt “tilt_plus”. Thereafter the various error rates “Err”, “Err_minus” and “Err_plus” can be distinguished (as step S240 in FIG. 2) from each other in a value difference. The three error rates “Err”, “Err_minus” and “Err_plus” are distributed along a positive-sloped side of the curve “U” depicted in the coordinate of FIG. 3(b). This leads the tilt to be adjusted toward the left side of the curve “U” along the horizontal axis of the coordinate.

During contiguous tilt adjustments toward the left or right of the curve “U”, a final result is shown in FIG. 3(c). A new “tilt0” is found adjacent to an invert point on the bottom of the curve “U”, of which a new error rate “Err” is smaller than its two nearby error rates “Err_minus” and “Err_plus” at both sides thereof. Therefore, the minimum decoding error rate as “Err” can be approached between the other error rates “Err_minus” and “Err_plus”. Also, an optimal tilt value is determined as a selected tilt value, correspondingly to the minimum decoding error rate by using a fine search step, and is output from the tilt control unit 50 to the tilt actuator 20 via the driver 60. The tilt actuator 20 controls the tilt of the pickup head 10 accessing the optical disk based on the selected tilt value for obtaining reading/writing qualities.

Please note that the tilt control unit 50 according to the present invention can adapt other algorithms to approach a minimum decoding error rate and is not limited by the algorithm shown in FIG. 2. In another case, the decoding error calculator 40 calculates a statistics such as a decoding error rate (e.g. a decoded physical address error rate or a data error rate) under each specific tilt value, based on the decoding errors transmitted from the decoder 30, for examples, number of decoding errors or averaged number of decoding errors within a specific reading length on the optical disk 100, or number of decoding errors or averaged decoding errors within a specific reading period for the optical disk 100, and containing the other error rates which are respectively achieved by performing an interpolation operation of the relative decoding error rates.

The tilt control unit 50 receives the statistics from the decoding error calculator 40. Then, within the statistics, the tilt control unit 50 compares the respective error rate with the other error rates to determine a minimum error rate that is minimal than the other error rates, or contiguously compares the respective statistic with the other statistics to determine a minimum statistic (as a minimum decoding error rate). Accordingly, an optimal tilt value is decided as a selected tilt value, correspondingly to the minimum error rate, by using a fine search step, and is output from the tilt control unit 50 to the tilt actuator 20 via the driver 60. The tilt actuator 20 controls the tilt of the pickup head 10 accessing the optical disk based on the selected tilt value for obtaining reading/writing qualities.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A tilt adjustment system applied for a pickup head operating on an optical disk that stores encoded information thereon, comprising:
a tilt control unit for generating a plurality of tilt value;
a tilt actuator for actuating the pickup head according to the tilt values generated from the tilt control unit;
a decoder for decoding the encoded information which is read from the optical disk by the pickup head, and checking whether any one decoding error occurs during decoding the encoded information; and
a decoding error calculator for calculating a statistics corresponding to the decoding errors generated under each different tilt value;
wherein the tilt control unit receives the statistics from the decoding error calculator and determines a selected tilt value according to the statistics corresponding to the plurality of tilt values, and the tilt actuator controls the pickup head accessing the optical disk based on the selected tilt value.

2. The system as claimed in claim 1 wherein the encoded information is read in a RF signal or a Wobble signal by the pickup head and has capabilities of error detection and correction.

3. The system as claimed in claim 2 wherein the optical disk is a recordable type, and the encoded information contains physical address information, and the decoding error is a decoded physical address information error.

4. The system as claimed in claim 2 wherein the optical disk is a read-only type or a recordable type with data written, the encoded information contains the written data, and the decoding error is a decoded data error.

5. The system as claimed in claim 1 wherein the decoding error calculator calculates the statistics containing each decoding error rate, with number of decoding errors or averaged number of decoding errors generated within either a specific reading length over the optical disk or a specific period of reading the optical disk, under each different tilt value.

6. The system as claimed in claim 5 wherein the decoding error calculator calculates the statistics containing the other error rates that are respectively achieved according to the decoding error rates.

7. The system as claimed in claim 6 wherein the tilt control unit determines the selected tilt value according to the statistics corresponding to the plurality of tilt values, by the following steps of:
(7a) Contiguously comparing the respective error rate with the other error rates within the statistics under the different tilt values;
(7b) Determining a minimum error rate which is minimal than the other error rates within the statistics; and
(7c) Deciding an optimal tilt value to be said selected tilt value by a fine search based on the minimum error rate.

8. The system as claimed in claim 1 wherein the tilt actuator receives an instruction from a driver in reference to each tilt value output from the tilt control unit to adjust the tilt of the pickup head with regard to the optical disk.

9. A tilt adjustment method applied for a pickup head operating on an optical disk that stores some encoded information thereon, comprising the following steps of:
(9a) Decoding the encoded information which is read from the optical disk by the pickup head, and checking whether any one decoding error occurs during decoding the encoded information;
(9b) Calculating a statistics corresponding to the decoding errors generated under each different tilt value;
(9c) Determining a selected tilt value according to the statistics corresponding to each different tilt value; and
(9d) Controlling the pickup head accessing the optical disk based on the selected tilt value.

10. The method as claimed in claim 9 wherein the encoded information is read in a RF signal or a Wobble signal by the pickup head and has capabilities of error detection and correction.

11. The method as claimed in claim 10 wherein the optical disk is a recordable type, and the encoded information contains physical address information, and the decoding error is a decoded physical address information error.

12. The method as claimed in claim 10 wherein the optical disk is a read-only type or a recordable type with data written, the encoded information contains the written data, and the decoding error is a decoded data error.

13. The method as claimed in claim 10 wherein the step (9b) further comprises a step of calculating the statistics as a decoding error rate, with number of decoding errors or averaged number of decoding errors generated within either a specific reading length over the optical disk or a specific period of reading the optical disk, under each different tilt value.

14. The method as claimed in claim 13 wherein the decoding error calculator calculates the statistics containing the other error rates that are respectively achieved according to the decoding error rates.

15. The method as claimed in claim 9 wherein the step (9c) further comprises the following steps of:
(15a) Contiguously comparing the respective statistic with the other statistics to determine a minimum statistic; and
(15b) Deciding the selected tilt value by a fine search based on the minimum statistic.
